(19) United States
(12) Patent Application Publication
(10) Pub. No.: US 2018/0257286 A1
(43) Pub. Date: Sep. 13, 2018

(54) Stretch Films and Methods for Making the Same

(71) Applicant: ExxonMobil Chemical Patents Inc., Baytown, TX (US)

(72) Inventors: Carolina A. Cateto, Brussels (BE); Michael J. Vinck, Western Cape (ZA); Achiel J. Van Loon, Antwerp (BE); Bart Lauwers, Antwerp (BE)

(21) Appl. No.: 15/861,008

(22) Filed: Jan. 3, 2018

Related U.S. Application Data
(60) Provisional application No. 62/469,662, filed on Mar. 10, 2017.

(51) Int. Cl. B29C 47/00; B29C 47/92; B32B 27/32; C08F 4/642; C08J 5/18; C08G 73/10; C08L 79/08

(52) U.S. Cl. CPC B29C 47/0021; B29C 47/92; B32B 27/32; C08L 79/08; C08J 5/18; C08G 73/10; C08F 4/642

(57) ABSTRACT

Disclosed are stretch films and methods for making the same, which can provide desired performance.

### PRIORITY CLAIM

This application claims priority to and benefit of U.S. Ser. No. 62/469,662, filed Mar. 10, 2017 and is incorporated herein by reference in its entirety.

### FIELD OF THE INVENTION

This invention relates to films, and in particular, to stretch films and methods for making such films.

### BACKGROUND OF THE INVENTION

Cast stretch film is a product used for pallet unitization and product bundling. It protects products from dust, moisture, and damage during transportation. In addition, it provides a low cost reliable method to package products. Cast stretch films include hand-wrap and machine-wrap films. Hand-wrap films are limited to stretch ratios of 100% or below, whereas machine-wrap films can go up to 400% stretch or higher. Cast stretch films can go from 5 to 50 μm, typically from 10 to 30 μm and can be composed of 3, 5, 7, or more layers. Moreover, the development of nanofeedblocks allows designing films with more than 33 layers.

Puncture and tear resistance, good cling, load stability and stretchability are key requirements for cast stretch films. For machine wrap applications, a high stretchability is of particular importance. At relatively high stretch ratios, the film imparts greater holding force and requires less film to pack or bundle a load which provides economic advantages. Nevertheless, stretchability must be balanced with puncture and tear resistance because the stretched film must also be able to provide a resistance to puncture/tearing from load protrusions and sharp corners during transportation.

According, a suitable selection and combination of polyolefin resins (such as polypropylene-based or polyethylene-based) in dedicated layers is crucial to meet these requirements. Polymers with low ethylene content can be used as a pure layer and/or in combination with polypropylene or polyethylene-based, in the range from 5 wt % to 100 wt % in the structural/functional layer to enhance the stretchability, puncture and tear resistance of the overall film. This layer can be a skin layer, a sub-skin layer, a functional core layer, one of the nanolayers, or any other layer within the stretch film, accounting for less than 30 wt % of the film structure. The low C₂ polymer can be present in one specific layer or in more layers, depending upon the film performance requirements. The present invention describes the use of the low C₂ polymer in a dual functional layer of a high performance power pre-stretch (HPPS) cast film and its corresponding film properties.

### SUMMARY OF THE INVENTION

In one aspect, embodiments described herein encompass a film, comprising: (a) a first outer layer comprising greater than about 50 wt %, based on the total weight of the first outer layer, of a propylene-based elastomer having at least about 60 wt % propylene-derived units and about 3 to about 25 wt % ethylene-derived units; (b) a second outer layer, wherein the first outer layer is not the same composition as the second outer layer; and (c) a core layer between the two outer layers, comprising greater than about 50 wt %, based on the total weight of the core layer, of an ethylene-based polymer.

### BRIEF DESCRIPTION OF THE FIGURES OF THE PRESENT INVENTION

FIG. 1 depicts a spider chart showing inventive and comparative films.

FIG. 2 depicts tear properties of the inventive and comparative films.

### DETAILED DESCRIPTION OF THE PRESENT INVENTION

Various specific embodiments, versions of the present invention will now be described, including preferred embodiments and definitions that are adopted herein. While the following detailed description gives specific preferred embodiments, those skilled in the art will appreciate that these embodiments are exemplary only, and that the present invention can be practiced in other ways. Any reference to the “invention” may refer to one or more, but not necessarily all, of the present inventions defined by the claims. The use of headings is for purposes of convenience only and does not limit the scope of the present invention.

As used herein, a “polymer” may be used to refer to homopolymers, copolymers, interpolymers, terpolymers, etc. A “polymer” has two or more of the same or different monomer units. A “homopolymer” is a polymer having monomer units that are the same. A “copolymer” is a polymer having two or more monomer units that are different from each other. A “terpolymer” is a polymer having three monomer units that are different from each other. The term “different” as used to refer to monomer units indicates that the monomer units differ from each other by at least one atom or are different isomerically. Accordingly, the definition of copolymer, as used herein, includes terpolymers and the like. Likewise, the definition of polymer, as used herein, includes copolymers and the like. Thus, as used herein, the terms “polyethylene,” “ethylene polymer,” “ethylene copolymer,” and “ethylene based polymer” mean a polymer or copolymer comprising at least 50 mol % ethylene units (preferably at least 70 mol % ethylene units, more preferably at least 80 mol % ethylene units, even more preferably at least 90 mol % ethylene units, even more preferably at least 95 mol % ethylene units or 100 mol % ethylene units (in the case of a homopolymer)). Furthermore, the term “polyethylene composition” means a composition containing one or more polyethylene components.

As used herein, when a polymer is referred to as comprising a monomer, the monomer is present in the polymer in the polymerized form of the monomer or in the derivative form of the monomer.

As used herein, when a polymer is said to comprise a certain percentage, wt %, of a monomer, that percentage of monomer is based on the total amount of monomer units in the polymer.

For purposes of this invention and the claims thereto, an ethylene polymer having a density of 0.910 to 0.940 g/cm³ is referred to as a “low density polyethylene” (LDPE); an ethylene polymer having a density of 0.890 to 0.930 g/cm³, typically from 0.910 to 0.930 g/cm³, that is linear and does not contain a substantial amount of long-chain branching is referred to as “linear low density polyethylene” (LLDPE) and can be produced with conventional Ziegler-Natta catalysts, vanadium catalysts, or with metallocene catalysts in gas phase reactors, high pressure tubular reactors, and/or in slurry reactors and/or with any of the disclosed catalysts in solution reactors (“linear” means that the polyethylene has no or only a few long-chain branches, typically referred to as a g′ᵥᵢₛ of 0.97 or above, preferably 0.98 or above); and an ethylene polymer having a density of more than 0.940 g/cm³ is referred to as a “high density polyethylene” (HDPE).

As used herein, “elastomer” or “elastomer composition” refers to any polymer or composition of polymers (such as blends of polymers) consistent with the ASTM D1566 definition. Elastomer includes mixed blends of polymers such as melt mixing and/or reactor blends of polymers.

As used herein, “core” layer, “outer” layer, and “inner” layer are merely identifiers used for convenience, and shall not be construed as limitation on individual layers, their relative positions, or the laminated structure, unless otherwise specified herein.

As used herein, “first” polyethylene, “second” polyethylene, “third” polyethylene, “first” propylene-based elastomer, and “second” propylene-based elastomer are merely identifiers used for convenience, and shall not be construed as limitation on individual polyethylene or propylene-based elastomer, their relative order, or the number of polyethylenes or propylene-based elastomers used, unless otherwise specified herein.

As used herein, film layers that are the same in composition and in thickness are referred to as “identical” layers.

### Propylene-Based Elastomer

The propylene-based elastomer useful in the multilayer film described herein is a copolymer of propylene-derived units and units derived from at least one of ethylene or a C₄-C₁₀ alpha-olefin. The propylene-based elastomer may contain at least about 50 wt % propylene-derived units. The propylene-based elastomer may have limited crystallinity due to adjacent isotactic propylene units and a melting point as described herein. The crystallinity and the melting point of the propylene-based elastomer can be reduced compared to highly isotactic polypropylene by the introduction of errors in the insertion of propylene. The propylene-based elastomer is generally devoid of any substantial intermolecular heterogeneity in tacticity and comonomer composition, and also generally devoid of any substantial heterogeneity in intramolecular composition distribution.

The amount of propylene-derived units present in the propylene-based elastomer may range from an upper limit of about 95 wt %, about 94 wt %, about 92 wt %, about 90 wt %, or about 85 wt %, to a lower limit of about 60 wt %, about 65 wt %, about 70 wt %, about 75 wt %, about 80 wt %, about 84 wt %, or about 85 wt %, of the propylene-based elastomer.

The units, or comonomers, derived from at least one of ethylene or a C₄-C₁₀ alpha-olefin may be present in an amount of about 1 to about 35 wt %, or about 5 to about 35 wt %, or about 7 to about 30 wt %, or about 8 to about 25 wt %, or about 8 to about 20 wt %, or about 8 to about 18 wt %, of the propylene-based elastomer. The comonomer content may be adjusted so that the propylene-based elastomer has a heat of fusion of less than about 80 J/g, a melting point of about 105° C. or less, and a crystallinity of about 2% to about 65% of the crystallinity of isotactic polypropylene, and a fractional melt mass-flow rate of about 0.5 to about 20 g/min.

In preferred embodiments, the comonomer is ethylene, 1-hexene, or 1-octene, with ethylene being most preferred. In embodiments where the propylene-based elastomer comprises ethylene-derived units, the propylene-based elastomer may comprise about 3 to about 25 wt %, or about 5 to about 20 wt %, or about 9 to about 18 wt % of ethylene-derived units. In some embodiments, the propylene-based elastomer consists essentially of units derived from propylene and ethylene, i.e., the propylene-based elastomer does not contain any other comonomer in an amount other than that typically present as impurities in the ethylene and/or propylene feedstreams used during polymerization, or in an amount that would materially affect the heat of fusion, melting point, crystallinity, or fractional melt mass-flow rate of the propylene-based elastomer, or in an amount such that any other comonomer is intentionally added to the polymerization process.

In some embodiments, the propylene-based elastomer may comprise more than one comonomer. Preferred embodiments of a propylene-based elastomer having more than one comonomer include propylene-ethylene-octene, propylene-ethylene-hexene, and propylene-ethylene-butene polymers. In embodiments where more than one comonomer derived from at least one of ethylene or a C₄-C₁₀ alpha-olefin is present, the amount of one comonomer may be less than about 5 wt % of the propylene-based elastomer, but the combined amount of comonomers of the propylene-based elastomer is about 5 wt % or greater.

The propylene-based elastomer may have a triad tacticity of three propylene units, as measured by ¹³C NMR, of at least about 75%, at least about 80%, at least about 82%, at least about 85%, or at least about 90%. Preferably, the propylene-based elastomer has a triad tacticity of about 50 to about 99%, or about 60 to about 99%, or about 75 to about 99%, or about 80 to about 99%. In some embodiments, the propylene-based elastomer may have a triad tacticity of about 60 to 97%.

The propylene-based elastomer has a heat of fusion (“H_{f}”), as determined by DSC, of about 80 J/g or less, or about 70 J/g or less, or about 50 J/g or less, or about 40 J/g or less.

The propylene-based elastomer may have a lower limit H_{f} of about 0.5 J/g, or about 1 J/g, or about 5 J/g. For example, the H_{f} value may range from a lower limit of about 1.0, 1.5, 3.0, 4.0, 6.0, or 7.0 J/g, to an upper limit of about 35, 40, 50, 60, 70, 75, or 80 J/g.

The propylene-based elastomer may have a percent crystallinity, as determined according to ASTM D3418-03 with a 10° C./min heating/cooling rate, of about 2 to about 65%, or about 0.5 to about 40%, or about 1 to about 30%, or about 5 to about 35%, of the crystallinity of isotactic polypropylene. The thermal energy for the highest order of propylene (i.e., 100% crystallinity) is estimated at 189 J/g. In some embodiments, the copolymer has crystallinity less than 40%, or in the range of about 0.25 to about 25%, or in the range of about 0.5 to about 22%, of the crystallinity of isotactic polypropylene.

Embodiments of the propylene-based elastomer may have a tacticity index m/r from a lower limit of about 4, or about 6, to an upper limit of about 8, or about 10, or about 12. In some embodiments, the propylene-based elastomer has an isotacticity index greater than 0%, or within the range having an upper limit of about 50%, or about 25%, and a lower limit of about 3%, or about 10%.

In some embodiments, the propylene-based elastomer may further comprise diene-derived units (as used herein, “diene”). The optional diene may be any hydrocarbon structure having at least two unsaturated bonds wherein at least one of the unsaturated bonds is readily incorporated into a polymer. For example, the optional diene may be selected from straight chain acyclic olefins, such as 1,4-hexadiene and 1,6-octadiene; branched chain acyclic olefins, such as 5-methyl-1,4-hexadiene, 3,7-dimethyl-1,6-octadiene, and 3,7-dimethyl-1,7-octadiene; single ring alicyclic olefins, such as 1,4-cyclohexadiene, 1,5-cyclooctadiene, and 1,7-cyclododecadiene; multi-ring alicyclic fused and bridged ring olefins, such as tetrahydroindene, norbornadiene, methyl-tetrahydroindene, dicyclopentadiene, bicyclo-(2.2.1)-hepta-2,5-diene, norbornadiene, alkenyl norbornenes, alkylidene norbornenes, e.g., ethylidiene norbornene (“ENB”), cycloalkenyl norbornenes, and cycloalkylene norbornenes (such as 5-methylene-2-norbornene, 5-ethylidene-2-norbornene, 5-propenyl-2-norbornene, 5-isopropylidene-2-norbornene, 5-(4-cyclopentenyl)-2-norbornene, 5-cyclohexylidene-2-norbornene, 5-vinyl-2-norbornene); and cycloalkenyl-substituted alkenes, such as vinyl cyclohexene, allyl cyclohexene, vinyl cyclooctene, 4-vinyl cyclohexene, allyl cyclodecene, vinyl cyclododecene, and tetracyclo (A-11,12)-5,8-dodecene. The amount of diene-derived units present in the propylene-based elastomer may range from an upper limit of about 15%, about 10%, about 7%, about 5%, about 4.5%, about 3%, about 2.5%, or about 1.5%, to a lower limit of about 0%, about 0.1%, about 0.2%, about 0.3%, about 0.5%, about 1%, about 3%, or about 5%, based on the total weight of the propylene-based elastomer.

The propylene-based elastomer may have a single peak melting transition as determined by DSC. In some embodiments, the copolymer has a primary peak transition of about 90° C. or less, with a broad end-of-melt transition of about 110° C. or greater. The peak “melting point” (“Tₘ”) is defined as the temperature of the greatest heat absorption within the range of melting of the sample. However, the copolymer may show secondary melting peaks adjacent to the principal peak, and/or at the end-of-melt transition. For the purposes of this disclosure, such secondary melting peaks are considered together as a single melting point, with the highest of these peaks being considered the Tₘ of the propylene-based elastomer. The propylene-based elastomer may have a Tₘ of about 110° C. or less, about 105° C. or less, about 100° C. or less, about 90° C. or less, about 80° C. or less, or about 70° C. or less. In some embodiments, the propylene-based elastomer has a Tₘ of about 25 to about 110° C., or about 40 to about 105° C., or about 60 to about 105° C. Tₘ of the propylene-based elastomer can be determined by ASTM D3418-03 with a 10° C./min heating/cooling rate.

The propylene-based elastomer may have a density of about 0.850 to about 0.900 g/cm³, or about 0.860 to about 0.880 g/cm³, at room temperature as measured based on ASTM D1505.

The propylene-based elastomer may have a fractional melt mass-flow rate (MFR), as measured based on ASTM D1238, 2.16 kg at 230° C., of at least about 0.5 g/10 min. In some embodiments, the propylene-based elastomer may have a fractional MFR of about 0.5 to about 20 g/10 min, or about 2 to about 18 g/10 min.

The propylene-based elastomer may have an Elongation at Break of less than about 2000%, less than about 1800%, less than about 1500%, or less than about 1000%, as measured based on ASTM D638.

The propylene-based elastomer may have a weight average molecular weight (M_{w}) of about 5,000 to about 5,000,000 g/mol, or about 10,000 to about 1,000,000 g/mol, or about 50,000 to about 400,000 g/mol. The propylene-based elastomer may have a number average molecular weight (Mₙ) of about 2,500 to about 250,000 g/mol, or about 10,000 to about 250,000 g/mol, or about 25,000 to about 250,000 g/mol. The propylene-based elastomer may have a z-average molecular weight (M_{z}) of about 10,000 to about 7,000,000 g/mol, or about 80,000 to about 700,000 g/mol, or about 100,000 to about 500,000 g/mol.

The propylene-based elastomer may have a molecular weight distribution (“MWD”) of about 1.5 to about 20, or about 1.5 to about 15, or about 1.5 to about 5, or about 1.8 to about 3, or about 1.8 to about 2.5.

Weight-average molecular weight, M_{w}, molecular weight distribution (MWD) or M_{w}/Mₙ where Mₙ is the number-average molecular weight, and the branching index, g′(vis), are characterized using a High Temperature Size Exclusion Chromatograph (SEC), equipped with a differential refractive index detector (DRI), an online light scattering detector (LS), and a viscometer. Experimental details not shown below, including how the detectors are calibrated, are described in: T. Sun, P. Brant, R. R. Chance, and W. W. Graessley, Macromolecules, Volume 34, Number 19, pp. 6812-6820, 2001. In one or more embodiments, the polymer blend can have a polydispersity index of from about 1.5 to about 6.

Solvent for the SEC experiment is prepared by dissolving 6 g of butylated hydroxy toluene as an antioxidant in 4 L of Aldrich reagent grade 1,2,4 trichlorobenzene (TCB). The TCB mixture is then filtered through a 0.7 μm glass pre-filter and subsequently through a 0.1 μm Teflon filter. The TCB is then degassed with an online degasser before entering the SEC. Polymer solutions are prepared by placing the dry polymer in a glass container, adding the desired amount of TCB, then heating the mixture at 160° C. with continuous agitation for about 2 hr. All quantities are measured gravimetrically. The TCB densities used to express the polymer concentration in mass/volume units are 1.463 g/mL at room temperature and 1.324 g/mL at 135° C. The injection concentration ranges from 1.0 to 2.0 mg/mL, with lower concentrations being used for higher molecular weight samples. Prior to running each sample the DRI detector and the injector are purged. Flow rate in the apparatus is then increased to 0.5 mL/min, and the DRI was allowed to stabilize for 8-9 hr before injecting the first sample. The LS laser is turned on 1 to 1.5 hr before running samples. As used herein, the term “room temperature” is used to refer to the temperature range of about 20° C. to about 23.5° C.

The concentration, c, at each point in the chromatogram is calculated from the baseline-subtracted DRI signal, I_{DRI}, using the following equation:

c=K_{DRI}I_{DRI}/(dn/dc),

where K_{DRI} is a constant determined by calibrating the DRI, and dn/dc is the same as described below for the LS analysis. Units on parameters throughout this description of the SEC method are such that concentration is expressed in g/cm³, molecular weight is expressed in kg/mol, and intrinsic viscosity is expressed in dL/g.

The light scattering detector used is a Wyatt Technology High Temperature mini-DAWN. The polymer molecular weight, M, at each point in the chromatogram is determined by analyzing the LS output using the Zimm model for static light scattering (M. B. Huglin, Light Scattering from Polymer Solutions, Academic Press, 1971):

[Kₒc/ΔR(θ,c)]=[1/MP(θ)]+2A₂c,

where ΔR(θ) is the measured excess Rayleigh scattering intensity at scattering angle θ, c is the polymer concentration determined from the DRI analysis, A₂ is the second virial coefficient, P(θ) is the form factor for a monodisperse random coil (described in the above reference), and Kₒ is the optical constant for the system:

$${K}_{o} = \frac{4 {π}^{2} {{n}^{2} ( dn \text{/} d c )}^{2}}{{λ}^{4} {N}_{A}} ,$$

in which N_{A} is the Avogadro' s number, and dn/dc is the refractive index increment for the system. The refractive index, n=1.500 for TCB at 135° C. and λ=690 nm. In addition, A₂=0.0015 and dn/dc=0.104 for ethylene polymers, whereas A₂=0.0006 and dn/dc=0.104 for propylene polymers.

The molecular weight averages are usually defined by considering the discontinuous nature of the distribution in which the macromolecules exist in discrete fractions i containing Nᵢ molecules of molecular weight Mᵢ. The weight-average molecular weight, M_{w}, is defined as the sum of the products of the molecular weight Mᵢ of each fraction multiplied by its weight fraction wᵢ:

M_{w} ≡ Σ wᵢMᵢ=(Σ NᵢMᵢ²/Σ NᵢMᵢ).

since the weight fraction wᵢ is defined as the weight of molecules of molecular weight Mᵢ divided by the total weight of all the molecules present:

wᵢ=NᵢMᵢ/Σ NᵢMᵢ.

The number-average molecular weight, Mₙ, is defined as the sum of the products of the molecular weight Mᵢ of each fraction multiplied by its mole fraction xᵢ:

Mₙ ≡ Σ xᵢMᵢ=Σ NᵢMᵢ/Σ Nᵢ,

since the mole fraction xᵢ is defined as Nᵢ divided by the total number of molecules:

xᵢ=Nᵢ/Σ Nᵢ.

In the SEC, a high temperature Viscotek Corporation viscometer is used, which has four capillaries arranged in a Wheatstone bridge configuration with two pressure transducers. One transducer measures the total pressure drop across the detector, and the other, positioned between the two sides of the bridge, measures a differential pressure. The specific viscosity, ηₛ, for the solution flowing through the viscometer is calculated from their outputs. The intrinsic viscosity, [η], at each point in the chromatogram is calculated from the following equation:

ηₛ=c[η]+0.3(c[η])^{2,}

where c was determined from the DRI output.

The branching index (g′, also referred to as g′(vis)) is calculated using the output of the SEC-DRI-LS-VIS method as follows. The average intrinsic viscosity, [η]_{avg}, of the sample is calculated by:

$${[ η ]}_{avg} = \frac{Σ {{c}_{i} [ η ]}_{i}}{Σ {c}_{i}} ,$$

where the summations are over the chromatographic slices, i, between the integration limits.

The branching index g′ is defined as:

$${g}^{′} = \frac{{[ η ]}_{avg}}{{kM}_{v}^{α}} ,$$

where k=0.000579 and α=0.695 for ethylene polymers; k=0.0002288 and α=0.705 for propylene polymers; and k=0.00018 and α=0.7 for butene polymers.

Mᵥ is the viscosity-average molecular weight based on molecular weights determined by the LS analysis:

Mᵥ≡(Σ cᵢMᵢ^{α}/Σ cᵢ)^{1/α.}

Suitable propylene-based elastomers may be available commercially under the trade names VISTAMAXX™ (ExxonMobil Chemical Company, Houston, Tex., USA), VERSIFY™ (The Dow Chemical Company, Midland, Mich., USA), certain grades of TAFMER™ XM or NOTIO™ (Mitsui Company, Japan), and certain grades of SOFTEL™ (Basell Polyolefins, Netherlands). The particular grade(s) of commercially available propylene-based elastomer suitable for use in the invention can be readily determined using methods commonly known in the art.

In one embodiment of the present invention, the multilayer film described herein comprises in the core layer a first propylene-based elastomer (as a propylene-based elastomer defined herein) having at least about 60 wt % propylene-derived units and about 3 to about 25 wt % ethylene-derived units, based on total weight of the first propylene-based elastomer, and a heat of fusion of less than about 80 J/g. Specifically, the first propylene-based elastomer may be an elastomer consisting essentially of units derived from propylene and ethylene, including propylene-crystallinity, a melting point by DSC equal to or less than 105° C., and a heat of fusion of from about 5 J/g to about 35 J/g. The propylene-derived units are present in an amount of about 80 to about 90 wt %, based on the total weight of the first propylene-based elastomer. The ethylene-derived units are present in an amount of about 8 to about 18 wt %, for example, about 8, about 8.5, about 9, about 9.5, about 10, about 10.5, about 11, about 11.5, about 12, about 12.5, about 13, about 13.5, about 14, about 14.5, about 15, about 15.5, about 16, about 16.5, about 17, about 17.5, about 18 wt %, based on the total weight of the first propylene-based elastomer.

In a preferred embodiment where the multilayer film described herein further comprises two inner layers each between the core layer and each outer layer, at least one of the inner layer comprises a second propylene-based elastomer (as a propylene-based elastomer defined herein) having at least about 60 wt % propylene-derived units and about 3 to about 25 wt % ethylene-derived units, based on total weight of the second propylene-based elastomer, and a heat of fusion of less than about 80 J/g. The second propylene-based elastomer may be the same as or different from the first propylene-based elastomer. Preferably, the second propylene-based elastomer is the same as the first propylene-based elastomer.

The first propylene-based elastomer in the core layer and optionally the second propylene-based elastomer in at least one of the inner layers (if present) in the multilayer film described herein may be optionally in a blend with one or more other polymers, such as propylene-based elastomers defined herein, which blend is referred to as propylene-based elastomer composition. The propylene-based elastomer composition may include one or more different propylene-based elastomers, i.e., propylene-based elastomers each having one or more different properties such as, for example, different comonomer or comonomer content. Such combinations of various propylene-based elastomers are all within the scope of the invention.

### Polyethylene

In one aspect of the invention, the polyethylene that can be used for the multilayer film described herein are selected from ethylene homopolymers, ethylene copolymers, and compositions thereof. Useful copolymers comprise one or more comonomers in addition to ethylene and can be a random copolymer, a statistical copolymer, a block copolymer, and/or compositions thereof. The method of making the polyethylene is not critical, as it can be made by slurry, solution, gas phase, high pressure or other suitable processes, and by using catalyst systems appropriate for the polymerization of polyethylenes, such as Ziegler-Natta-type catalysts, chromium catalysts, metallocene-type catalysts, other appropriate catalyst systems or combinations thereof, or by free-radical polymerization. In a preferred embodiment, the polyethylenes are made by the catalysts, activators and processes described in U.S. Pat. Nos. 6,342,566; 6,384,142; and 5,741,563; and WO 03/040201 and WO 97/19991. Such catalysts are well known in the art, and are described in, for example, ZIEGLER CATALYSTS (Gerhard Fink, Rolf Mülhaupt and Hans H. Brintzinger, eds., Springer-Verlag 1995); Resconi et al.; and I, II METALLOCENE-BASED POLYOLEFINS (Wiley & Sons 2000).

Polyethylenes that are useful in this invention include those sold by ExxonMobil Chemical Company in Houston Tex., including HDPE, LLDPE, and LDPE; and those sold under the ENABLE™, EXACT™, EXCEED™, ESCORENE™, EXXCO™, ESCOR™, PAXON™, and OPTEMA™ tradenames

Preferred ethylene homopolymers and copolymers useful in this invention typically have one or more of the following properties:

1. an M_{w} of 20,000 g/mol or more, 20,000 to 2,000,000 g/mol, preferably 30,000 to 1,000,000, preferably 40,000 to 200,000, preferably 50,000 to 750,000, as determined by the method described herein; and/or

2. a Tₘ of 30° C. to 150° C., preferably 30° C. to 140° C., preferably 50° C. to 140° C., more preferably 60° C. to 135° C., as determined based on ASTM D3418-03 with a heating/cooling rate of 10° C./min; and/or

3. a crystallinity of 5% to 80%, preferably 10% to 70%, more preferably 20% to 60%, preferably at least 30%, or at least 40%, or at least 50%, as determined based on ASTM D3418-03 with a heating/cooling rate of 10° C./min; and/or

4. a heat of fusion of 300 J/g or less, preferably 1 to 260 J/g, preferably 5 to 240 J/g, preferably 10 to 200 J/g, as determined based on ASTM D3418-03 with a heating/cooling rate of 10° C./min; and/or

5. a crystallization temperature (T_{c}) of 15° C. to 130° C., preferably 20° C. to 120° C., more preferably 25° C. to 110° C., preferably 60° C. to 125° C., as determined based on ASTM D3418-03 with a heating/cooling rate of 10° C./min; and/or

6. a heat deflection temperature of 30° C. to 120° C., preferably 40° C. to 100° C., more preferably 50° C. to 80° C. as measured based on ASTM D648 on injection molded flexure bars, at 66 psi load (455 kPa); and/or

7. a Shore hardness (D scale) of 10 or more, preferably 20 or more, preferably 30 or more, preferably 40 or more, preferably 100 or less, preferably from 25 to 75 (as measured based on ASTM D 2240); and/or

8. a percent amorphous content of at least 50%, preferably at least 60%, preferably at least 70%, more preferably between 50% and 95%, or 70% or less, preferably 60% or less, preferably 50% or less as determined by subtracting the percent crystallinity from 100.

The polyethylene may be an ethylene homopolymer, such as HDPE. In one embodiment, the ethylene homopolymer has a molecular weight distribution (M_{w}/Mₙ) or (MWD) of up to 40, preferably ranging from 1.5 to 20, or from 1.8 to 10, or from 1.9 to 5, or from 2.0 to 4. In another embodiment, the 1% secant flexural modulus (determined based on ASTM D790A, where test specimen geometry is as specified under the ASTM D790 section “Molding Materials (Thermoplastics and Thermosets),” and the support span is 2 inches (5.08 cm)) of the polyethylene falls in a range of 200 to 1000 MPa, and from 300 to 800 MPa in another embodiment, and from 400 to 750 MPa in yet another embodiment, wherein a desirable polymer may exhibit any combination of any upper flexural modulus limit with any lower flexural modulus limit. The MI of preferred ethylene homopolymers range from 0.05 to 800 dg/min in one embodiment, and from 0.1 to 100 dg/min in another embodiment, as measured based on ASTM D1238 (190° C., 2.16 kg).

In a preferred embodiment, the polyethylene comprises less than 20 mol % propylene units (preferably less than 15 mol %, preferably less than 10 mol %, preferably less than 5 mol %, and preferably 0 mol % propylene units).

In another embodiment of the invention, the polyethylene useful herein is produced by polymerization of ethylene and, optionally, an alpha-olefin with a catalyst having, as a transition metal component, a bis (n-C₃₋₄ alkyl cyclopentadienyl) hafnium compound, wherein the transition metal component preferably comprises from about 95 mol % to about 99 mol % of the hafnium compound as further described in U.S. Pat. No. 9,956,088.

In another embodiment of the invention, the polyethylene is an ethylene copolymer, either random or block, of ethylene and one or more comonomers selected from C₃ to C₂₀ α-olefins, typically from C₃ to C₁₀ α-olefins. Preferably, the comonomers are present from 0.1 wt % to 50 wt % of the copolymer in one embodiment, and from 0.5 wt % to 30 wt % in another embodiment, and from 1 wt % to 15 wt % in yet another embodiment, and from 0.1 wt % to 5 wt % in yet another embodiment, wherein a desirable copolymer comprises ethylene and C₃ to C₂₀ α-olefin derived units in any combination of any upper wt % limit with any lower wt % limit described herein. Preferably the ethylene copolymer will have a weight average molecular weight of from greater than 8,000 g/mol in one embodiment, and greater than 10,000 g/mol in another embodiment, and greater than 12,000 g/mol in yet another embodiment, and greater than 20,000 g/mol in yet another embodiment, and less than 1,000,000 g/mol in yet another embodiment, and less than 800,000 g/mol in yet another embodiment, wherein a desirable copolymer may comprise any upper molecular weight limit with any lower molecular weight limit described herein.

In another embodiment, the ethylene copolymer comprises ethylene and one or more other monomers selected from the group consisting of C₃ to C₂₀ linear, branched or cyclic monomers, and in some embodiments is a C₃ to C₁₂ linear or branched alpha-olefin, preferably butene, pentene, hexene, heptene, octene, nonene, decene, dodecene, 4-methyl-pentene-1,3-methyl pentene-1,3,5,5-trimethyl-hexene-1, and the like. The monomers may be present at up to 50 wt %, preferably from up to 40 wt %, more preferably from 0.5 wt % to 30 wt %, more preferably from 2 wt % to 30 wt %, more preferably from 5 wt % to 20 wt %, based on the total weight of the ethylene copolymer.

Preferred linear alpha-olefins useful as comonomers for the ethylene copolymers useful in this invention include C₃ to C₈ alpha-olefins, more preferably 1-butene, 1-hexene, and 1-octene, even more preferably 1-hexene. Preferred branched alpha-olefins include 4-methyl-1-pentene, 3-methyl-1-pentene, 3,5,5-trimethyl-1-hexene, and 5-ethyl-1-nonene. Preferred aromatic-group-containing monomers contain up to 30 carbon atoms. Suitable aromatic-group-containing monomers comprise at least one aromatic structure, preferably from one to three, more preferably a phenyl, indenyl, fluorenyl, or naphthyl moiety. The aromatic-group-containing monomer further comprises at least one polymerizable double bond such that after polymerization, the aromatic structure will be pendant from the polymer backbone. The aromatic-group containing monomer may further be substituted with one or more hydrocarbyl groups including but not limited to C₁ to C₁₀ alkyl groups. Additionally, two adjacent substitutions may be joined to form a ring structure. Preferred aromatic-group-containing monomers contain at least one aromatic structure appended to a polymerizable olefinic moiety. Particularly, preferred aromatic monomers include styrene, alpha-methylstyrene, para-alkylstyrenes, vinyltoluenes, vinylnaphthalene, allyl benzene, and indene, especially styrene, paramethyl styrene, 4-phenyl-1-butene and allyl benzene.

Preferred diolefin monomers useful in this invention include any hydrocarbon structure, preferably C₄ to C₃₀, having at least two unsaturated bonds, wherein at least two of the unsaturated bonds are readily incorporated into a polymer by either a stereospecific or a non-stereospecific catalyst(s). It is further preferred that the diolefin monomers be selected from alpha, omega-diene monomers (i.e., di-vinyl monomers). More preferably, the diolefin monomers are linear di-vinyl monomers, most preferably those containing from 4 to 30 carbon atoms. Examples of preferred dienes include butadiene, pentadiene, hexadiene, heptadiene, octadiene, nonadiene, decadiene, undecadiene, dodecadiene, tridecadiene, tetradecadiene, pentadecadiene, hexadecadiene, heptadecadiene, octadecadiene, nonadecadiene, icosadiene, heneicosadiene, docosadiene, tricosadiene, tetracosadiene, pentacosadiene, hexacosadiene, heptacosadiene, octacosadiene, nonacosadiene, triacontadiene, particularly preferred dienes include 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, and low molecular weight polybutadienes (Mw less than 1000 g/mol). Preferred cyclic dienes include cyclopentadiene, vinylnorbornene, norbornadiene, ethylidene norbornene, divinylbenzene, dicyclopentadiene, or higher ring containing diolefins with or without substituents at various ring positions.

In a preferred embodiment, one or more dienes are present in the polyethylene at up to 10 wt %, preferably at 0.00001 wt % to 2 wt %, preferably 0.002 wt % to 1 wt %, even more preferably 0.003 wt % to 0.5 wt %, based upon the total weight of the polyethylene. In some embodiments, diene is added to the polymerization in an amount of from an upper limit of 500 ppm, 400 ppm, or 300 ppm to a lower limit of 50 ppm, 100 ppm, or 150 ppm.

Preferred ethylene copolymers useful herein are preferably a copolymer comprising at least 50 wt % ethylene and having up to 50 wt %, preferably 1 wt % to 35 wt %, even more preferably 1 wt % to 6 wt % of a C₃ to C₂₀ comonomer, preferably a C₄ to C₈ comonomer, preferably hexene or octene, based upon the weight of the copolymer. Preferably these polymers are metallocene polyethylenes (mPEs).

Useful mPE homopolymers or copolymers may be produced using mono- or bis-cyclopentadienyl transition metal catalysts in combination with an activator of alumoxane and/or a non-coordinating anion in solution, slurry, high pressure or gas phase. The catalyst and activator may be supported or unsupported and the cyclopentadienyl rings may be substituted or unsubstituted. Several commercial products produced with such catalyst/activator combinations are commercially available from ExxonMobil Chemical Company in Houston, Tex. under the tradename EXCEED™ mPE or ENABLE™ mPE.

In a class of embodiments, the multilayer film described herein comprises a first polyethylene (as a polyethylene defined herein) in at least one of the outer layers. Preferably, the first polyethylene has a density of about 0.900 to about 0.945 g/cm³, a melt index (MI), I_{2.16}, of about 0.1 to about 15 g/10 min, a molecular weight distribution (MWD) of about 1.5 to about 5.5, and a melt index ratio (MIR), I_{21.6}/I_{2.16}, of about 10 to about 100. More preferably, the first polyethylene has a density of about 0.900 to about 0.920 g/cm³, a melt index (MI), I_{2.16}, of about 0.5 to about 5 g/10 min, a molecular weight distribution (MWD) of about 1.5 to about 5.5, and a melt index ratio (MIR), I_{21.6}/I_{2.16}, of about 10 to about 25.

In various embodiments, the first polyethylene may have one or more of the following properties:

(a) a density (sample prepared according to ASTM D-4703, and the measurement according to ASTM D-1505) of about 0.900 to 0.945 g/cm³, or about 0.910 to about 0.935 g/cm³;

(b) a Melt Index (“MI”, I_{2.16}, ASTM D-1238, 2.16 kg, 190° C.) of about 0.1 to about 15 g/10 min, or about 0.3 to about 10 g/10 min, or about 0.5 to about 5 g/10 min;

(c) a Melt Index Ratio (“MIR”, I_{21.6} (190° C., 21.6 kg)/I_{2.16} (190° C., 2.16 kg)) of about 10 to about 100, or about 10 to about 50, or about 10 to about 25;

(d) a Composition Distribution Breadth Index (“CDBI”) of up to about 85%, or up to about 75%, or about 5 to about 85%, or 10 to 75%. The CDBI may be determined using techniques for isolating individual fractions of a sample of the resin. The preferred technique is Temperature Rising Elution Fraction (“TREF”), as described in Wild, et al., J. Poly. Sci., Poly. Phys. Ed., Vol. 20, p. 441 (1982), which is incorporated herein for purposes of U.S. practice;

(e) a molecular weight distribution (“MWD”) of about 1.5 to about 5.5, and/or

(f) a branching index of about 0.9 to about 1.0, or about 0.96 to about 1.0, or about 0.97 to about 1.0. Branching Index is an indication of the amount of branching of the polymer and is defined as g′=[Rg]²_{br}/[Rg]²ₗᵢₙ. “Rg” stands for Radius of Gyration, and is measured using a Waters 150 gel permeation chromatograph equipped with a Multi-Angle Laser Light Scattering (“MALLS”) detector, a viscosity detector and a differential refractive index detector. “[RG]_{br}” is the Radius of Gyration for the branched polymer sample and “[Rg]ₗᵢₙ” is the Radius of Gyration for a linear polymer sample. The branching index is inversely proportional to the amount of branching. Thus, lower values for g′ indicate relatively higher amounts of branching. The amounts of short and long-chain branching each contribute to the branching index according to the formula: g′=g′_{LCB}×g′_{SCB}. Thus, the branching index due to long-chain branching may be calculated from the experimentally determined value for g′ as described by Scholte, et al, in J. App. Polymer Sci., 29, pp. 3763-3782 (1984), incorporated herein by reference.

The first polyethylene is not limited by any particular method of preparation and may be formed using any process known in the art. For example, the first polyethylene may be formed using gas phase, solution, or slurry processes.

In one embodiment, the first polyethylene is formed in the presence of a metallocene catalyst. For example, the first polyethylene may be an mPE produced using mono- or bis-cyclopentadienyl transition metal catalysts in combination with an activator of alumoxane and/or a non-coordinating anion in solution, slurry, high pressure or gas phase. The catalyst and activator may be supported or unsupported and the cyclopentadienyl rings may be substituted or unsubstituted. mPEs useful as the first polyethylene include those commercially available from ExxonMobil Chemical Company in Houston, Tex., such as those sold under the trade designation EXCEED™.

In accordance with another preferred embodiment where the first propylene-based elastomer used in the core layer has an ethylene content of less than or equal to about 13 wt % (based on total weight of the first propylene-based elastomer), the multilayer film described herein further comprises in the core layer a second polyethylene, as a polyethylene defined herein. Typically, the second polyethylene useful in the present invention may be characterized by a branching index, g′ᵥᵢₛ, of about 0.40 to about 0.45, preferably about 0.40 to about 0.43, about 0.40 to about 0.42, or about 0.41 to about 0.42.

In various embodiments, the second polyethylene as described herein may further have one or more of the following properties:

(a) a density (sample prepared according to ASTM D-4703, and the measurement according to ASTM D-1505) of about 0.910 to 0.940 g/cm³, or about 0.912 to about 0.935 g/cm³, or about 0.915 to about 0.925 g/cm³;

(b) a Melt Index (“MI”, I_{2.16}, ASTM D1238, 2.16 kg, 190° C.) of about 0.1 to about 10 g/10 min, or about 0.3 to about 8 g/10 min, or about 0.5 to about 5 g/10 min;

(c) a molecular weight distribution (“MWD”) of about 4 to about 40, and/or

(d) a Vicat softening point (according to ASTM D1525) of about 20° C. to about 80° C., or about 30° C. to about 60° C.

In one embodiment, the second polyethylene is LDPE. The LDPEs that are useful in the core layer of the multilayer films described herein are ethylene based polymers produced by free radical initiation at high pressure in a tubular or autoclave reactor as well known in the art. The free radicals trigger the incorporation of chain lengths along the length of a main chain so forming long chain branches, usually by what is known as a back-biting mechanism. The branches vary in length and configuration. The average molecular weight can be controlled with a variety of telogens or transfer agents which may incorporate at the chain ends or along the chain. Comonomers may be used such as olefins other than ethylene or minor amounts of olefinically copolymerizable monomers containing polar moieties such a carbonyl group. Particularly suitable LDPEs used as the second polyethylene described herein are ethylene homopolymers, which are available from ExxonMobil Chemical Company under the tradename ExxonMobil™ LDPE.

In another preferred embodiment where two inner layers each between the core layer and each outer layer is present, the multilayer film described herein comprises a third polyethylene, as a polyethylene defined herein, in at least one of the inner layer. Preferably, the third polyethylene has a density of about 0.900 to about 0.945 g/cm³, a melt index (MI), I_{2.16}, of about 0.1 to about 15 g/10 min, a molecular weight distribution (MWD) of about 1.5 to about 5.5, and a melt index ratio (MIR), I_{21.6}/I_{2.16}, of about 10 to about 100. More preferably, the third polyethylene has a density of about 0.900 to about 0.915 g/cm³, a melt index (MI), I_{2.16}, of about 0.5 to about 5 g/10 min, a molecular weight distribution (MWD) of about 1.5 to about 5.5, and a melt index ratio (MIR), I_{21.6}/I_{2.16}, of about 10 to about 25. In various embodiments, the third polyethylene may have one or more of the properties or be prepared as defined above for the first polyethylene. The third polyethylene may be the same as or different from the first polyethylene. Preferably, the third polyethylenes is different from the first polyethylene in a lower density. Preferably, the third polyethylene has a density no higher than about 0.912 g/cm³.

The third polyethylene is not limited by any particular method of preparation and may be formed using any process known in the art. In one embodiment, the third polyethylene is formed in the presence of a metallocene catalyst. mPEs useful as the third polyethylene include those commercially available from ExxonMobil Chemical Company in Houston, Tex., such as those sold under the trade designation EXCEED™.

The first polyethylene present in at least one of the outer layers, the second polyethylene optionally present in the core layer, and the third polyethylene optionally present in at least one of the inner layers of the multilayer film described herein may be optionally in a blend with one or more other polymers, such as polyethylenes defined herein, which blend is referred to as polyethylene composition. In particular, the polyethylene compositions described herein may be physical blends or in situ blends of more than one type of polyethylene or compositions of polyethylenes with polymers other than polyethylenes where the polyethylene component is the majority component, e.g., greater than 50 wt % of the total weight of the composition. Preferably, the polyethylene composition is a blend of two polyethylenes with different densities.

### Additives

The multilayer film described herein may also contain in at least one layer various additives as generally known in the art. Examples of such additives include a slip agent, an antiblock, a filler, an antioxidant, an ultraviolet light stabilizer, a thermal stabilizer, a pigment, a processing aid, a crosslinking catalyst, a flame retardant, and a foaming agent, etc. Preferably, the additives may each individually present in an amount of about 0.01 wt % to about 50 wt %, or about 0.1 wt % to about 10 wt %, or from 1 wt % to 5 wt %, based on total weight of the film layer.

In a preferred embodiment, at least one of a slip agent and an antiblock is employed in any or each of the two outer layer and the core layer of the multilayer film described herein to control the coefficient of friction to ensure slippery surface exposed to the bubble interior and deliver desired winding and unwinding properties during blown extrusion. Additives may also impact sealing property of the formed film.

Any additive useful for the multilayer film may be provided separately or together with other additive(s) of the same or a different type in a pre-blended masterbatch, where the target concentration of the additive is reached by combining each neat additive component in an appropriate amount to make the final composition.

### Film Structures

The multilayer film of the present invention may further comprise additional layer(s), which may be any layer typically included in multilayer film constructions. For example, the additional layer(s) may be made from:

1. Polyolefins. Preferred polyolefins include homopolymers or copolymers of C₂ to C₄₀ olefins, preferably C₂ to C₂₀ olefins, preferably a copolymer of an α-olefin and another olefin or α-olefin (ethylene is defined to be an α-olefin for purposes of this invention). Preferably homopolyethylene, homopolypropylene, propylene copolymerized with ethylene and/or butene, ethylene copolymerized with one or more of propylene, butene or hexene, and optional dienes. Preferred examples include thermoplastic polymers such as ultra-low density polyethylene, very low density polyethylene, linear low density polyethylene, low density polyethylene, medium density polyethylene, high density polyethylene, polypropylene, isotactic polypropylene, highly isotactic polypropylene, syndiotactic polypropylene, random copolymer of propylene and ethylene and/or butene and/or hexene, elastomers such as ethylene propylene rubber, ethylene propylene diene monomer rubber, neoprene, and compositions of thermoplastic polymers and elastomers, such as, for example, thermoplastic elastomers and rubber toughened plastics.

2. Polar polymers. Preferred polar polymers include homopolymers and copolymers of esters, amides, acetates, anhydrides, copolymers of a C₂ to C₂₀ olefin, such as ethylene and/or propylene and/or butene with one or more polar monomers, such as acetates, anhydrides, esters, alcohol, and/or acrylics. Preferred examples include polyesters, polyamides, ethylene vinyl acetate copolymers, and polyvinyl chloride.

3. Cationic polymers. Preferred cationic polymers include polymers or copolymers of geminally disubstituted olefins, α-heteroatom olefins and/or styrenic monomers. Preferred geminally disubstituted olefins include isobutylene, isopentene, isoheptene, isohexane, isooctene, isodecene, and isododecene. Preferred α-heteroatom olefins include vinyl ether and vinyl carbazole, preferred styrenic monomers include styrene, alkyl styrene, para-alkyl styrene, α-methyl styrene, chloro-styrene, and bromo-para-methyl styrene. Preferred examples of cationic polymers include butyl rubber, isobutylene copolymerized with para methyl styrene, polystyrene, and poly-α-methyl styrene.

4. Miscellaneous. Other preferred layers can be paper, wood, cardboard, metal, metal foils (such as aluminum foil and tin foil), metallized surfaces, glass (including silicon oxide (SiOₓ) coatings applied by evaporating silicon oxide onto a film surface), fabric, spunbond fibers, and non-wovens (particularly polypropylene spunbond fibers or non-wovens), and substrates coated with inks, dyes, pigments, and the like.

In particular, a multilayer film can also include layers comprising materials such as ethylene vinyl alcohol (EVOH), polyamide (PA), polyvinylidene chloride (PVDC), or aluminum, so as to obtain barrier performance for the film where appropriate.

In one aspect of the invention, the multilayer film described herein may be produced in a stiff oriented form (often referred to as “pre-stretched” by persons skilled in the art) and may be useful for laminating to inelastic materials, such as polyethylene films, biaxially oriented polyester (e.g., polyethylene terephthalate (PET)) films, biaxially oriented polypropylene (BOPP) films, biaxially oriented polyamide (nylon) films, foil, paper, board, or fabric substrates, or may further comprise one of the above substrate films to form a laminate structure.

The thickness of the multilayer films may range from about 10 to about 200 μm in general and is mainly determined by the intended use and properties of the film. Stretch films may be thin; those for shrink films or heavy duty bags are much thicker. Conveniently, the multilayer film described herein has a thickness of from about 10 to about 200 μm, from about 10 to about 150 μm, or from about 30 to about 130 μm.

The multilayer film described herein may have an A/Y/A′ structure wherein A and A′ are outer layers and Y is the core layer in contact with the outer layer. Suitably one or both outer layers are a skin layer forming one or both film surfaces and can serve as a lamination skin (the surface to be adhered to a substrate film) or a sealable skin (the surface to form a seal). The composition of the A′ and A layers may be the same or different, but conform to the limitations set out herein. Preferably, the A layers are not identical. The multilayer film may have an A′/B/X/B/A structure wherein A and A′ are outer layers and X represents the core layer and B are inner layers between the core layer and each outer layer. The composition of the A and A′ layers may be the same or different, but conform to the limitations set out herein. Preferably, the A and A′ layers are not identical. The composition of the B layers may also be the same or different, but conform to the limitations set out herein. The multilayer film may be three, five, seven, or more layers.

### Film Properties and Applications

Films described herein can be used for any purpose, but are particularly suited to stretch film applications. The film described herein comprising it can display outstanding properties as demonstrated by tensile strength, resistance to puncture and tearing, elastic recovery, transparency, which is especially important for stretch film applications. The multilayer film described herein can be used to establish a sufficient holding force and also to optimize the film behavior during extension and after contraction around a load on a stretch hood packaging line with reduced risk of tearing or puncturing.

### Methods for Making the Film

Also provided are methods for making multilayer films of the present invention. A method for making a multilayer film may comprise the steps of preparing a first outer layer comprising greater than about 50 wt %, based on the total weight of the first outer layer, of a propylene-based elastomer having at least about 60 wt % propylene-derived units and about 3 to about 25 wt % ethylene-derived units; preparing a second outer layer, wherein the first outer layer is not the same composition as the second outer layer; and preparing a core layer between the two outer layers, comprising greater than about 50 wt %, based on the total weight of the core layer, of an ethylene-based polymer; and (d) forming a film comprising the layers in steps (a), (b), and (c).

The multilayer films described herein may be formed by any of the conventional techniques known in the art including blown extrusion, cast extrusion, coextrusion, blow molding, casting, and extrusion blow molding. Preferably, the film is prepared using processes to prepare cast films known in the industry.

### EXAMPLES

The present invention, while not meant to be limited by, may be better understood by reference to the following example and Table 1.

Ultimate Stretch is a measure of the ultimate elongation, in %, of the film as it is stretched at a certain rate. Ultimate Stretch was conducted at a test speed of 55 m/min.

Stretch Force is a measure of the force obtained by stretching the film 200%. The test speed was 55 m/min.

Puncture Force is measured based on CEN 14477, and is a measure of the maximum force to penetrate the film at a given stretch percentage of 250% when a probe moves a distance of 7.6 cm through the film.

Elmendorf Tear strength is measured based on ASTM D1922-06a using the Tear Tester 83-11-01 from TMI Group of Companies and measures the energy required to continue a pre-cut tear in the test sample, presented as tearing force in gram. Samples were cut across the web using the constant radius tear die and were free of any visible defects (e.g., die lines, gels, etc.).

Cling Force is measured based on ASTM D5458-95.

Puncture Resistance is a measure of the maximum force to puncture the film at a given pre-stretch percentage. The film is wrapped using a Lantech Q300XT film wrapping machine and a wooden box 12 times at a speed of 15 rpm, thereby pre-stretching the film to 300%. The film is then observed for the presence or absence of holes near the puncture bars during the wrapping process. A film has good puncture resistance if there are no holes at the puncture bar. A film has poor puncture resistance if there are holes at the puncture bar.

Tear Propagation Resistance is a measure of the size of a puncture in the film and its increase in size over time. The film is wrapped using a Lantech Q300XT film wrapping machine and a wooden box 12 times at a speed of 15 rpm, thereby pre-stretching the film to 300%. A 2 cm long vertical incision is made in the film. The film is observed for 1 minute. A film has good tear propagation resistance if the size of the incision in the film remains approximately the same size after 1 minute. A film has poor tear propagation resistance if the size of the incision in the film increases substantially after 1 minute.

Film Examples 13B (inventive) and 12B (comparative) are three layer films having an outer cling layer, an inner core layer, and an outer non-cling layer. Both films comprise 10 wt % the outer cling layer, 75 wt % the inner core layer, and 15 wt % the outer non-cling layer. Each of the films, Examples 13B and 12B, are 15 μm thick. Each of the films were made in a 3-layer co-extruded cast line with 3 extruders and a 1.5 m die. The line speed was 500 m/min, the die gap was 0.6 mm

TABLE 1
FILM FORMULATIONS (wt % based on Film Composition)

| Film Sample | | | Layer A |
|---|---|---|---|
| No. | Layer C (Cling Layer) | Layer B (Core Layer) | (Non-Cling Layer) |
| 13B | 94% LL1004YB/ | 90% LL1004YB/ | 100% Vistamaxx 6000 |
| (inventive) | 6% Vistamaxx 6202 | 10% Enable 20-10CB | |
| 12B | 94% LL1004YB/ | 90% Exceed 3518CB/ | 85% Exceed 3518CB/ |
| (comparative) | 6% Vistamaxx 6202 | 10% Enable 20-10CB | 15% Enable 20-10CB |

The difference in composition between Examples 13B and 12B are the inner core layer and outer non-cling layer. For Example 13B, the inner core layer includes a linear low density polyethylene catalyzed with Ziegler-Natta catalyst, whereas for Example 12B, the inner core layer includes a polyethylene catalyzed with metallocene catalyst. For Example 13B, the outer non-cling layer has only a propylene-ethylene copolymer, whereas for Example 12B, the outer non-cling layer has a blend of two ethylene-hexene copolymers.

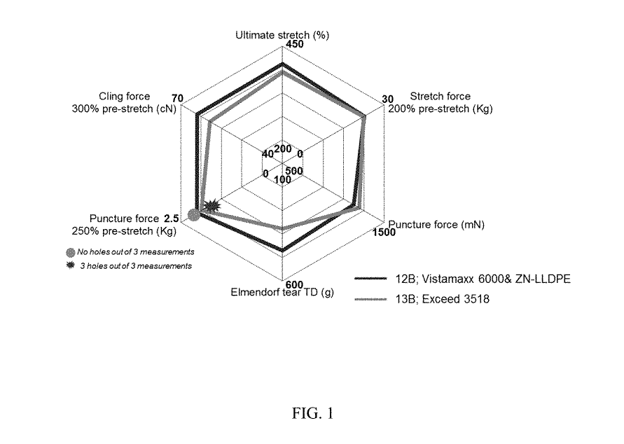

The films were evaluated for Ultimate Stretch, Stretch Force (at 200% pre-stretch), Puncture Force (and Puncture Force at 250% pre-stretch), Elmendorf Tear, and Cling Force (at 300% pre-stretch). The results are shown in the spider chart of FIG. 1. As shown in FIG. 1, Example 13B with inventive non-cling layer provides a favorably higher Elmendorf tear, improved puncture resistance at high stretch ratio (i.e., no holes) and improved cling force, as compared to Example 12B.

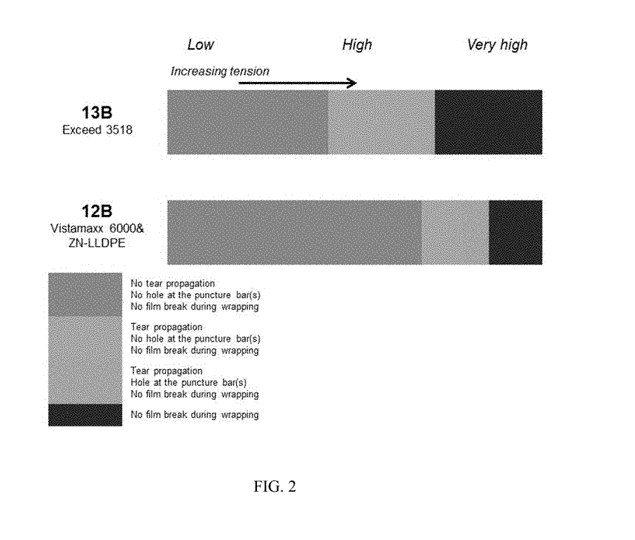

The films were also evaluated for puncture resistance and tear propagation resistance at high stretch ratio (300% pre-stretch), as illustrated in FIG. 2. Example 13B with inventive non-cling layer provides improved tear propagation resistance and puncture resistance at high stretch ratio and tension, as compared to Example 12B.

It can be seen from FIGS. 1 and 2 that the inventive film 13B, featuring an outer non-cling layer rich in propylene-based elastomer, can enhance stretchability, cling force, puncture resistance, Elmendorf tear, and tear propagation resistance of the film, demonstrating a better-balanced overall performance than that achievable with the conventional ethylene-based copolymer containing three-layer film 12B.

Particularly, without being bound by theory, it is believed that the flexibility in adjusting layer composition and structure depending on ethylene content of the propylene-based elastomer used can be exploited to conveniently provide benefits in improving property profile and overall film performance in response to growing demands of different stretch hood applications.

All documents described herein are incorporated by reference herein, including any priority documents and/or testing procedures. When numerical lower limits and numerical upper limits are listed herein, ranges from any lower limit to any upper limit are contemplated. As is apparent from the foregoing general description and the specific embodiments, while forms of the invention have been illustrated and described, various modifications can be made without departing from the spirit and scope of the invention.

What is claimed is:

1. A multilayer film, comprising:
(a) a first outer layer comprising greater than about 50 wt %, based on the total weight of the first outer layer, of a propylene-based elastomer having at least about 60 wt % propylene-derived units and about 3 to about 25 wt % ethylene-derived units;
(b) a second outer layer, wherein the first outer layer has a different composition than the second outer layer; and
(c) a core layer between the two outer layers, comprising greater than about 50 wt %, based on the total weight of the core layer, of an ethylene-based polymer.

2. The multilayer film of claim 1, wherein the first outer layer consists essentially of the propylene-based elastomer.

3. The multilayer film of claim 1, wherein the ethylene-derived units in the propylene-based elastomer of the first outer layer are present in an amount of at least about 13 wt %, based on total weight of the first propylene-based elastomer.

4. The multilayer film of claim 1, wherein the ethylene-derived units in the propylene-based elastomer of the first outer layer are present in an amount of less than or equal to about 13 wt %, based on total weight of the first propylene-based elastomer.

5. The multilayer film of claim 1, wherein the ethylene-based polymer of the core layer has a molecular weight distribution of from about 1.5 to about 20.

6. The multilayer film of claim 1, wherein the ethylene-based polymer of the core layer is a linear low density polyethylene.

7. The multilayer film of claim 1, wherein the core layer consists essentially of the ethylene-based copolymer.

8. The multilayer film of claim 1, wherein the second outer layer comprises a second propylene-based elastomer and an ethylene-based polymer.

9. The multilayer film of claim 8, wherein the second propylene-based elastomer has a different composition than the first propylene-based elastomer.

10. The multilayer film of claim 8, wherein the second propylene-based elastomer is present in the second outer layer in the amount of about 5 to about 15 wt %, based on the total weight of the second outer layer.

11. The multilayer film of claim 1, wherein the thickness ratio between each of the outer layers and the core layer is 1:7.5:1.5.

12. The multilayer film of claim 1, wherein the multilayer film has a thickness of from about 10 to about 150 μm.

13. The multilayer film of claim 1, wherein at least one layer comprises at least one of a slip agent, an antiblock, a filler, an antioxidant, an ultraviolet light stabilizer, a thermal stabilizer, a pigment, a processing aid, a crosslinking catalyst, a flame retardant, and a foaming agent.

14. A cling film comprising the multilayer film of claim 1.
